(19) United States
(12) Patent Application Publication
(10) Pub. No.: US 2024/0253789 A1
(43) Pub. Date: Aug. 1, 2024

(54) TRANSFORMABLE SEAT SYSTEMS AND METHODS FOR AN INTERNAL CABIN OF AN AIRCRAFT

(71) Applicant: THE BOEING COMPANY, Arlington, VA (US)

(72) Inventors: Cynthia Vandewall, Snohomish, WA (US); Jared Bowen, Lynnwood, WA (US); Henry Levesque, Cincinnati, OH (US); Alejandro Lozano Robledo, Cincinnati, OH (US); Juan Sebastian Ramirez Loaiza, Cincinnati, OH (US); Yibo Jiao, Cincinnati, OH (US)

(73) Assignee: THE BOEING COMPANY, Arlington, VA (US)

(21) Appl. No.: 18/160,338

(22) Filed: Jan. 27, 2023

(51) Int. Cl. B64D 11/06

(52) U.S. Cl. CPC B64D 11/064

(57) ABSTRACT

A seat system is configured to be within an internal cabin of a vehicle. The seat system includes a backrest, and a seat support moveable between a seating position and a standing position. The backrest and the seat support are configured to support an individual in a seated orientation when the seat support is in the seating position. Further, the backrest and the seat support are configured to support the individual in a standing orientation when the seat support is in the standing position.

### FIELD OF THE DISCLOSURE

Examples of the present disclosure generally relate to transformable seat systems and methods for an internal cabin of an aircraft.

### BACKGROUND OF THE DISCLOSURE

Aircraft are used to transport passengers and cargo between various locations. A typical commercial aircraft includes a passenger seating area within an internal cabin. Passenger seats are arranged in rows. For example, a row within the internal cabin includes a first set of two or three seats separated from a second set of two or three seats by a portion of an aisle that extends between the first and second sets of seats.

During a flight, passengers can be seated in individual seats for long periods of time. However, the ability to move about the internal cabin to stretch and walk is limited, such as due to potential congestion in aisles.

### SUMMARY OF THE DISCLOSURE

A need exists for a seat that allows a passenger to extend legs and stretch without moving about an internal cabin of an aircraft. Further, a need exists for a seat for an internal cabin of an aircraft that promotes movement during a flight.

With those needs in mind, certain examples of the present disclosure provide a seat system configured to be within an internal cabin of a vehicle. The seat system includes a backrest, and a seat support moveable between a seating position and a standing position. The backrest and the seat support are configured to support an individual in a seated orientation when the seat support is in the seating position. The backrest and the seat support are configured to support the individual in a standing orientation when the seat support is in the standing position.

In at least one example, the seat system also includes one or more panels. The seat support is moveably coupled to the one or more panels. As an example, the seat support is pivotally coupled to the one or more panels by a pivot member. The seat system can also include a lock operatively coupled to the pivot member. The lock is configured to lock the seat support in a desired position.

In at least one example, the backrest is moveably coupled to the one or more panels. For example, the backrest is moveably coupled to the one or more panels by a translator configured to allow the backrest to linearly translate in relation to the one or more panels.

The seat system can also include a tray table moveably secured to the one or more panels. The tray table is configured to be moved between a privacy position and a forwardly-deployed position.

The seat system can also include a motor configured to automatically move the seat support between the seating position and the standing position. The seat system can also include a lock configured to lock the backrest in a desired position. The seat system can also include a motor configured to automatically move the backrest.

In at least one example, the seat system is configured to be secured to one or more seat tracks within a floor of the internal cabin.

Certain examples of the present disclosure provide an aircraft including an internal cabin, and a seat system within the internal cabin, as described herein.

Certain examples of the present disclosure provide a method for a seat system within an internal cabin of a vehicle. The seat system includes a backrest and a seat support. The method includes moving the seat support between a seating position and a standing position. The backrest and the seat support are configured to support an individual in a seated orientation when the seat support is in the seating position. The backrest and the seat support are configured to support the individual in a standing orientation when the seat support is in the standing position.

### BRIEF DESCRIPTION OF THE DRAWINGS

FIG. 1 illustrates a block diagram of a seat system within an internal cabin of a vehicle, according to an example of the present disclosure.

FIG. 2 illustrates a perspective front view of an aircraft, according to an example of the present disclosure.

FIG. 3A illustrates a top plan view of an internal cabin of an aircraft, according to an example of the present disclosure.

FIG. 3B illustrates a top plan view of an internal cabin of an aircraft, according to an example of the present disclosure.

FIG. 4 illustrates a perspective front view of a seat system having a seat support in a seating position and a tray table in a privacy position, according to an example of the present disclosure.

FIG. 5 illustrates a perspective front view of the seat system of FIG. 4 having the seat support in the seating position, and the tray table in a forwardly-deployed position.

FIG. 6 illustrates a perspective front view of the seat system of FIG. 4 having the seat support in the standing position, and the tray table in the privacy position.

FIG. 7 illustrates a perspective front view of the seat system of FIG. 4 having the seat support in the standing position, and the tray table in the forwardly-deployed position.

FIG. 8 illustrates a perspective front view of seat systems within an internal cabin of a vehicle, according to an example of the present disclosure.

FIG. 9 illustrates a flow chart of a method, according to an example of the present disclosure.

### DETAILED DESCRIPTION OF THE DISCLOSURE

The foregoing summary, as well as the following detailed description of certain examples will be better understood when read in conjunction with the appended drawings. As used herein, an element or step recited in the singular and preceded by the word “a” or “an” should be understood as not necessarily excluding the plural of the elements or steps. Further, references to “one example” are not intended to be interpreted as excluding the existence of additional examples that also incorporate the recited features. Moreover, unless explicitly stated to the contrary, examples “comprising” or “having” an element or a plurality of elements having a particular condition can include additional elements not having that condition.

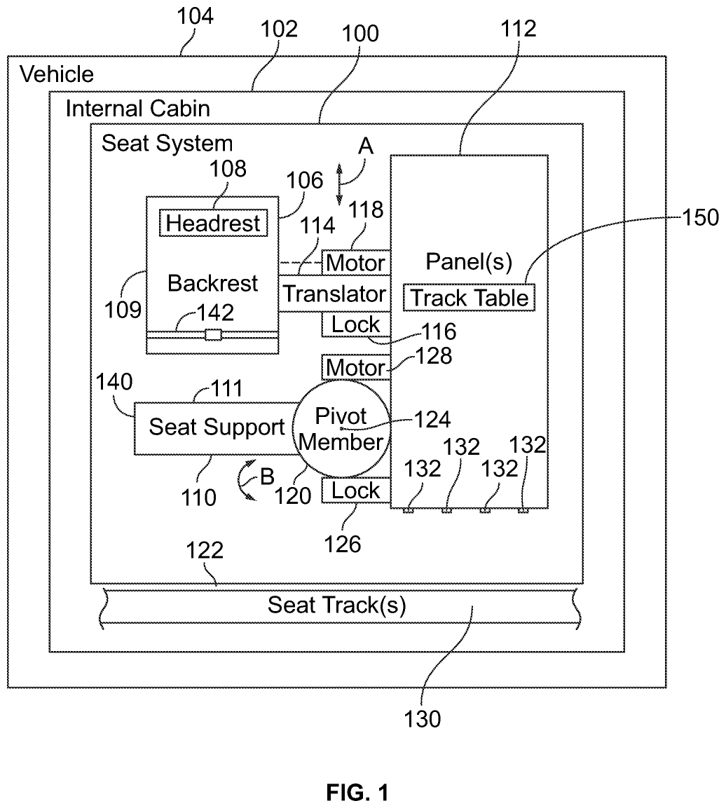

FIG. 1 illustrates a block diagram of a seat system 100 within an internal cabin 102 of a vehicle 104, according to an example of the present disclosure. In at least one example, the vehicle 104 is a commercial aircraft. Optionally, the vehicle 104 can be a land-based vehicle, such as a bus or train car, a watercraft, a spacecraft, or the like. The seat system 100 provides a transformable seat assembly for the internal cabin 102 of the vehicle.

The seat system 100 is configured to selectively transform from a first position, such as a seating position in which a passenger can sit, to a second position, such as a standing position that allows a passenger to stand during a trip, such as a flight of a commercial aircraft. The seat system 100 includes a backrest 106, which can include a headrest 108. The seat system 100 further includes a seat support 110, such as a pan, basin, cushion, and/or the like, configured to support a passenger in a seated position. In at least one example, the seat support 110 is moveably coupled to the backrest 106, such as through one or more pivot axles. In at least one example, the seat system 100 includes one or more panels 112. The panel(s) 112 can be fixed in position. Optionally, at least a portion of the panel(s) 112 can be configured to move. The backrest 106 is moveably coupled to the panel(s) 112 by a translator 114, which can include one or more tracks, rails, or the like that cooperate with reciprocal structures of the backrest 106. The translator 114 is configured to allow the backrest 106 linearly translate in the directions of arrows A in relation to the panel(s) 112. In at least one example, a lock 116 can be coupled to the translator 114 and/or the backrest 106 to lock the backrest 106 in a desired position in relation to the panel(s) 112. Optionally, the seat system 100 may not include the lock 116. In at least one example, a motor 118 is operatively coupled to one or more of the backrest 106, the translator 114, and/or the panel(s) 112. The motor 118 is configured to automatically move the backrest 106 in relation to the panel(s) 112. Optionally, the seat system 100 may not include the motor 118.

In at least one example, the panel(s) 112 are also movable. As a further example, the motor(s) 118 and/or 128 (and/or another motor) can be configured to move portions of the panel(s) 112. For example, the panel(s) 112 can be configured to telescope so that that lines of sight can be maintained in the internal cabin when passengers are not in seated positions.

The seat support 110 is configured to pivot between the seating position and the standing position. For example, the seat support 110 is coupled to the panel(s) 112 by a pivot member 120, such as one or more axles, one or more cams, one or more gears, and/or the like. The seat support 110 is configured to pivot about a pivot axis 124 of the pivot member 120 in the directions of arc B between the seating position, such as a substantially horizontal orientation (for example, within =/−10 degrees) in relation to a floor 122 of the internal cabin 102, and the standing position, such as a substantially vertical orientation (for example, within =/−10 degrees) relative to an upper surface of the floor 122 (for example, substantially 90 degree angle between the seat support 110 and the upper surface of the floor 122) the internal cabin 102. In at least one example, a lock 126 can be coupled to the pivot member 124 and/or the seat support 110 to lock the seat support 110 in a desired position in relation to the panel(s) 112. Optionally, the seat system 100 may not include the lock 126. In at least one example, a motor 128 is operatively coupled to one or more of the seat support 110, the pivot member 120, and/or the panel(s) 112. The motor 128 is configured to automatically move the seat support 110 in relation to the panel(s) 112. Optionally, the seat system 100 may not include the motor 128.

In at least one example, the seat system 100 is secured to one or more seat tracks 130 that extend along at least a portion of the internal cabin 102. The seat tracks 130 can be embedded within the floor 122. Optionally, at least a portion of the seat tracks 130 can upwardly extend from the floor 122. In at least one example, securing studs 132 (such as shear studs) downwardly extend from lower surfaces of the panel(s) 112 (or optionally, one or more legs secured to the seat support 110). The securing studs 132 are securely retained within the seat tracks 130. The seat tracks 130 are configured to securely couple to the securing studs 132 to secure the seat system 100 in place. Optionally, the seat system 100 is not secured to seat tracks.

The seat system 100 is configured for vertical extension to allow a passenger to stand therein, in contrast to a seat that horizontally extends to allow a passenger to lay down. As such, the passenger is able to stretch legs, promote blood flow within legs, stand, and the like without moving into an aisle of the internal cabin.

In operation, in order to transform the seat system 100 from the seating position to the standing position, the backrest 106 is initially vertically translated, such as upwardly shifted in relation to the panel(s) 112 via the translator 114. The backrest 106 can be manually shifted, or automatically shifted via the motor 118. The lock 116 can be used to lock the backrest 106 in position. After the backrest 106 is shifted vertically upwardly, the seat support 110 is then downwardly pivoted via the pivot member 120. The seat support 110 can be manually pivoted in the directions of arc B, or automatically through the motor 128. A distal end 140 of the seat support 110 is pivoted away from the backrest 106 into the standing position. A passenger can downwardly pivot the seat support 110 to a desired standing position. For example, the standing position can include the seat support 110 being vertically aligned with the backrest 106 (for example, lying flat with each other). As another example, the standing position can include the seat support 110 angled in relation to the backrest 106 (such as an angle between respective passenger support surfaces 109 and 111 of the backrest 106 and the seat support 110). A desired standing position can include an angle between passenger support surfaces 109 and 111 between 110-180 degrees, for example. When the seat support 110 is in the standing position, a passenger is able to stand within the seating system 100. In order to return the seat support 110 to the seating position, the process is reversed.

In at least one example, a seatbelt 142 is secured to the backrest 106, which allows the seatbelt 142 to move along with the backrest 106, and secure a passenger in position whether in the seated position or the standing position. In at least one example, the backrest 106 is not configured to vertically translate. For example, the backrest 106 may not be coupled to a translator. Instead, the seat support 110 can be pivoted between the seating position and the standing position without the backrest 106 being vertically shifted.

In at least one example, a tray table 150 can be coupled to a portion of the seat system 100. For example, the tray table 150 can be moveably secured to the panel(s) 112, and/or the backrest 106. The tray table 150 is configured to be selectively moved between a stowed position (such as within an armrest or within a panel), and a deployed position (such as a forwardly-deployed position, which can provide a reading surface, a support for food items, and/or the like). In at least one example, the tray table 150 can also be moved into a privacy position. The tray table 150 can be used in both the seating position and the standing position, and can also be moved into a position to provide a privacy divider between adjacent seat systems. The tray table 150 can be oriented vertically and slid forward to create a privacy barrier between adjacent seat positions. The tray table 150 can be moved to a flat position when used to support objects, such as food items.

Optionally, a passenger with reduced mobility who is confined to a wheelchair is able to be secured within the seating system 100 when the seat support 110 is in the standing position. As such, the seating system 100 can be transformed into the standing position to allow a wheel chair to be secured within and/or to the seat system 100.

As described herein, the seat system 100 is configured to be within the internal cabin 102 of the vehicle 104, such as a commercial aircraft. The seat system 100 includes the backrest 106, and the seat support 110, which is moveable between the seating position and the standing position. The backrest 106 and the seat support 110 are configured to support an individual in a seated orientation (that is, the individual is seated on the seat support 110) when the seat support 110 is in the seating position. Further, the backrest 106 and the seat support 110 are configured to support the individual in a standing orientation (that is, the individual is able to stand on the floor 122 within the seat system 100) when the seat support 110 is in the standing position.

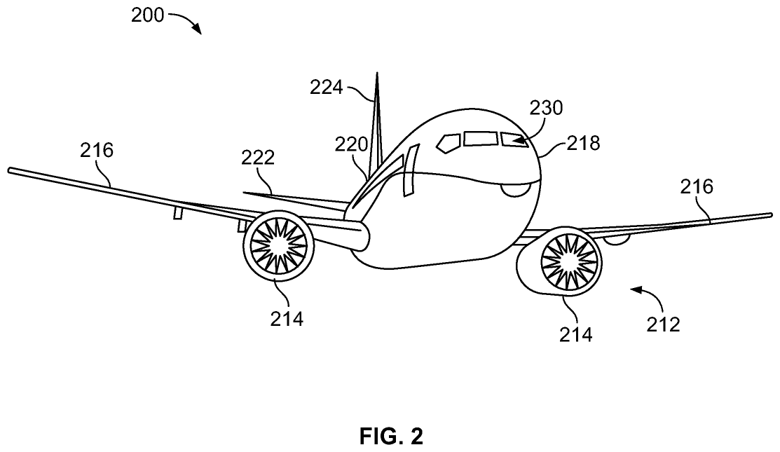

FIG. 2 illustrates a perspective front view of an aircraft 200, according to an example of the present disclosure. The aircraft 200 is an example of the vehicle 104 shown and described with respect to FIG. 1. The aircraft 200 includes a propulsion system 212 that includes engines 214, for example. Optionally, the propulsion system 212 may include more engines 214 than shown. The engines 214 are carried by wings 216 of the aircraft 200. In other examples, the engines 214 may be carried by a fuselage 218 and/or an empennage 220. The empennage 220 may also support horizontal stabilizers 222 and a vertical stabilizer 224. The fuselage 218 of the aircraft 200 defines an internal cabin 202, which includes a flight deck or cockpit, one or more work sections (for example, galleys, personnel carry-on baggage areas, and the like), one or more passenger sections (for example, first class, business class, and coach sections), one or more lavatories, and/or the like. FIG. 2 shows an example of an aircraft 200. It is to be understood that the aircraft 200 can be sized, shaped, and configured differently than shown in FIG. 2. Optionally, examples of the present disclosure can be used with various other vehicles. For example, instead of an aircraft, the vehicle can be a land-based vehicle, such as an automobile, a bus, a train car, or the like. As another example, the vehicle can be a watercraft. As another example, the vehicle can be a spacecraft.

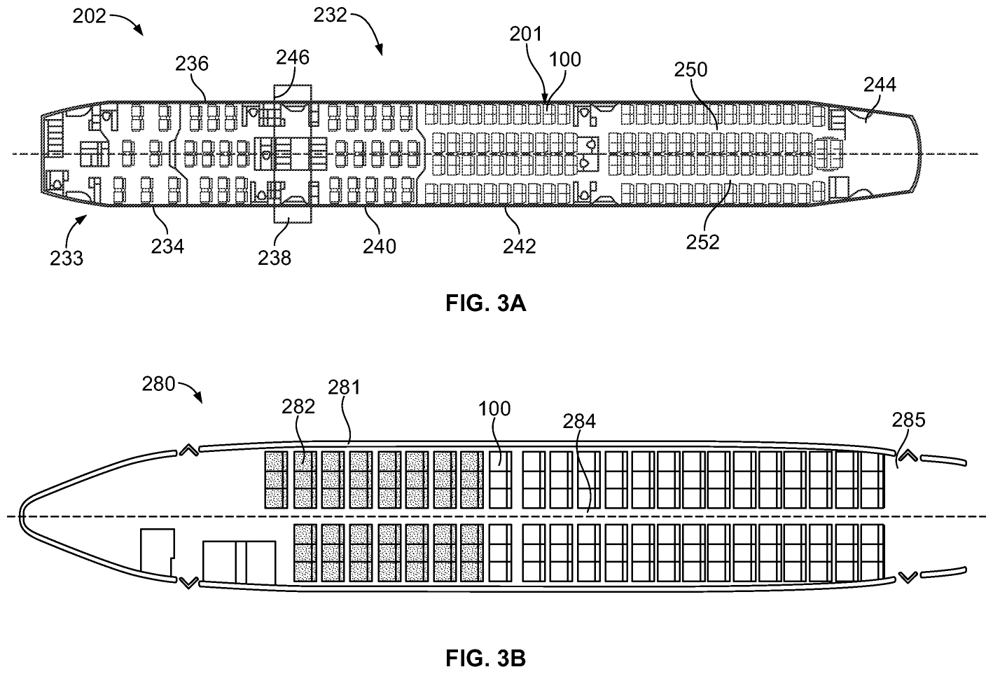

FIG. 3A illustrates a top plan view of an internal cabin 202 of an aircraft, according to an example of the present disclosure. The internal cabin 202 is an example of the internal cabin 102 shown and described with respect to FIG. 1. The internal cabin 202 may be within a fuselage 232 of the aircraft. For example, one or more fuselage walls may define an interior of the internal cabin 202. The interior of the internal cabin 202 is defined by sidewall panels that connect to a ceiling and a floor. The sidewall panels include lateral segments that connect to ceiling segments. The lateral segments define lateral wall portions, while the ceiling segments define at least portions of the ceiling within the internal cabin 202.

The internal cabin 202 includes multiple sections, including a front section 233, a first class section 234, a business class section 236, a front galley station 238, an expanded economy or coach section 240, a standard economy or coach section 242, and an aft section 244, which may include multiple lavatories and galley stations. It is to be understood that the internal cabin 202 may include more or less sections than shown. For example, the internal cabin 202 may not include a first class section, and may include more or less galley stations than shown.

As shown in FIG. 3A, the internal cabin 202 includes two aisles 250 and 252 that lead to the aft section 244. Optionally, the internal cabin 202 may have less or more aisles than shown. For example, the internal cabin 202 may include a single aisle that extends through the center of the internal cabin 202 that leads to the aft section 244.

Seat systems 100 are positioned throughout the internal cabin 202. The seat systems 100 may be arranged in rows 201. As described herein, the seat systems 100 are configured to be selectively moved seating positions and standing positions.

FIG. 3B illustrates a top plan view of an internal cabin 280 of an aircraft, according to an example of the present disclosure. The internal cabin 280 is an example of the internal cabin 102 shown and described with respect to FIG. 1. The internal cabin 280 may be within a fuselage 281 of the aircraft. For example, one or more fuselage walls may define the interior of the internal cabin 280. The internal cabin 280 includes multiple sections, including a main cabin 282 having one or more seat systems 100, and an aft section 285 behind the main cabin 282. It is to be understood that the internal cabin 280 may include more or less sections than shown.

The internal cabin 280 may include a single aisle 284 that leads to the aft section 285. The single aisle 284 may extend through the center of the internal cabin 280 that leads to the aft section 285. For example, the single aisle 284 may be coaxially aligned with a central longitudinal plane of the internal cabin 280.

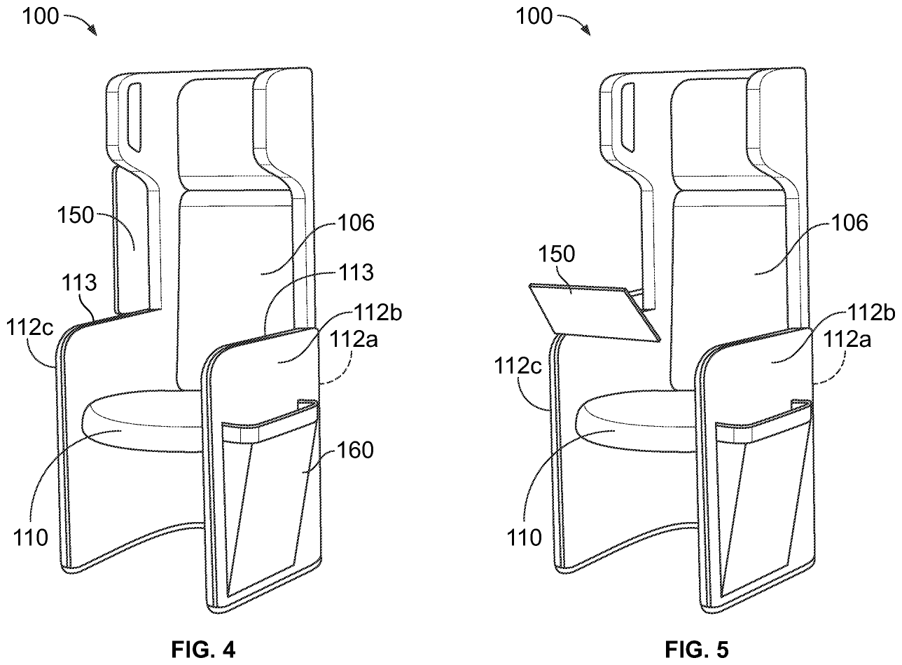

FIG. 4 illustrates a perspective front view of a seat system 100 having the seat support 110 in a seating position and a tray table 150 in a privacy position, according to an example of the present disclosure. In at least one example, the seat system 100 includes a rear panel 112a and lateral panels 112b and 112c forwardly extending from lateral edges of the rear panel 112a. Optionally, the seat system 100 may not include the lateral panels 112b and 112c.

Referring to FIGS. 1 and 4, the backrest 106 is moveably coupled to the rear panel 112a and/or the lateral panels 112b and 112c through the translator 114. Optionally, the backrest 106 can be fixed in position with respect to one or more of the rear panel 112a, and/or the lateral panels 112b and 112c. The lateral panels 112b and 112c can define armrests 113. Optionally, an armrest can be secured to one or both of the backrest 106 and/or the seat support 110.

The tray table 150 is moveably secured to the panel 112c and/or the panel 112a. For example, the tray table 150 can be moveably secured to the panel 112c and/or the panel 112a through one or more articulating arms, pivot joints, and/or the like. In the privacy position, as shown, the tray table 150 is upwardly oriented and aligned with a side surface of the panel 112c. In this manner, the tray table 150 provides a blocking barrier in relation to an adjacent seat system.

In at least one example, a storage pocket 160 is secured to the panel 112b. The storage pocket 160 can be used to store literature, for example. Optionally, the seat system 100 may not include the storage pocket.

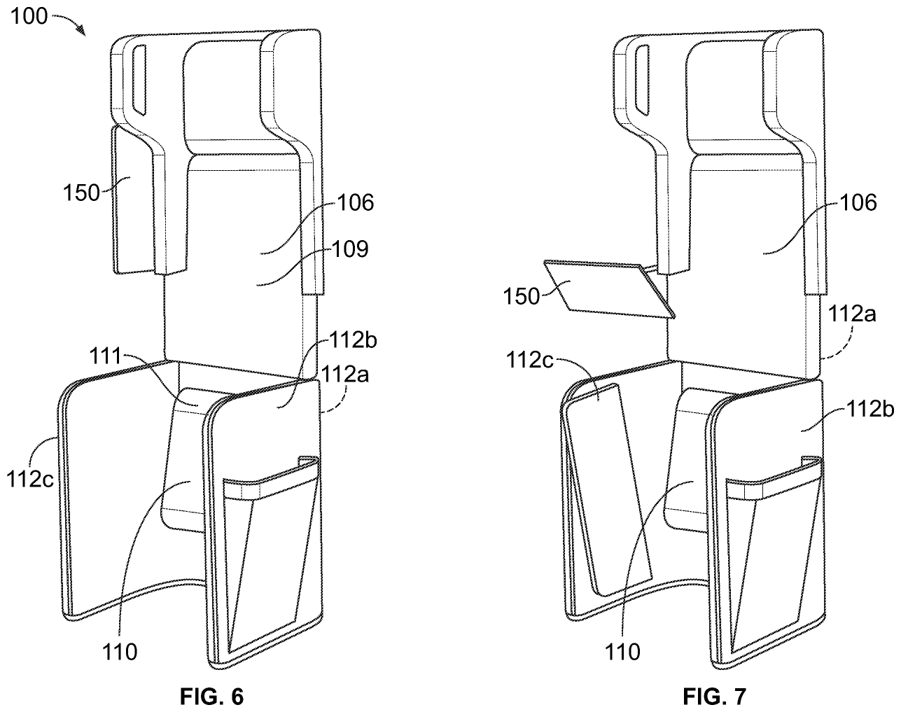

FIG. 5 illustrates a perspective front view of the seat system 100 of FIG. 4 having the seat support 110 in the seating position, and the tray table 150 in a forwardly-deployed position. The tray table 150 can be moved from a stowed position, or the privacy position into the forwardly-deployed position, as shown in FIG. 5.

FIG. 6 illustrates a perspective front view of the seat system 100 of FIG. 4 having the seat support 110 in the standing position, and the tray table 150 in the privacy position. As shown, in the standing position, the seat support 110 can be folded toward and/or against a front surface of the rear panel 112a. In this manner, the seat support 110 and the backrest 106 can provide a substantially flat vertical support for a standing passenger with the passenger support surfaces 109 and 111 being substantially vertical in relation to a floor of an internal cabin.

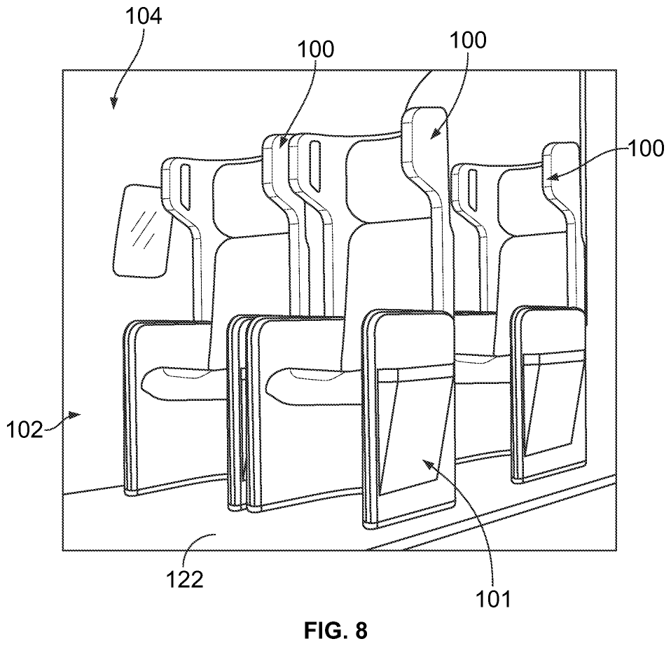

FIG. 7 illustrates a perspective front view of the seat system 100 of FIG. 4 having the seat support 110 in the standing position, and the tray table 150 in the forwardly-deployed position. Referring to FIGS. 4-7, the seat support 110 can be selectively moved between the seating position and the standing position (including positions therebetween), as desired.

FIG. 8 illustrates a perspective front view of seat systems 100 within an internal cabin 102 of a vehicle 104, according to an example of the present disclosure. The seat systems 100 can be secured to seat tracks within the floor 122. The seat systems 100 can be arranged in rows 101.

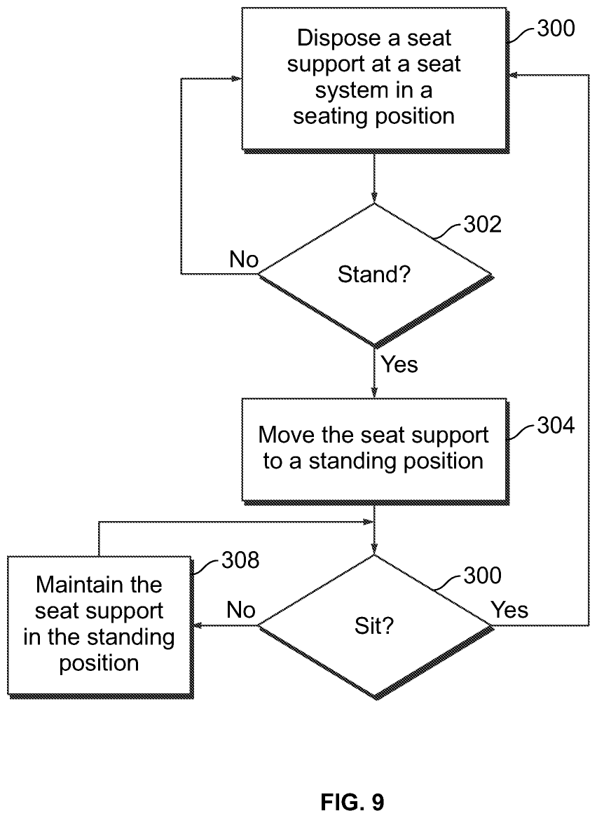

FIG. 9 illustrates a flow chart of a method, according to an example of the present disclosure. Referring to FIGS. 1 and 9, at 300, the seat support 110 of the seat system 100 is disposed in a seating position. At 302, an individual decides if he/she would like to stand. If not, the method returns to 300, at which the seat support 110 is maintained in the seating position. If, however, the individual desires to stand, the method proceeds from 302 to 304, at which the seat support 110 is moved to a standing position. At 306, the individual decides if he/she would like to sit. If not, the method proceeds from 306 to 308, at which the seat support 110 is maintained in the standing position. If, however, the individual desires to sit at 306, the method returns to 300.

Further, the disclosure comprises examples according to the following clauses:

Clause 1. A seat system configured to be within an internal cabin of a vehicle, the seat system comprising:
a backrest; and
a seat support moveable between a seating position and a standing position,
wherein the backrest and the seat support are configured to support an individual in a seated orientation when the seat support is in the seating position, and
wherein the backrest and the seat support are configured to support the individual in a standing orientation when the seat support is in the standing position.

Clause 2. The seat system of Clause 1, further comprising one or more panels, wherein the seat support is moveably coupled to the one or more panels.

Clause 3. The seat system of Clause 2, wherein the seat support is pivotally coupled to the one or more panels by a pivot member.

Clause 4. The seat system of Clause 3, further comprising a lock operatively coupled to the pivot member, wherein the lock is configured to lock the seat support in a desired position.

Clause 5. The seat system of any of Clauses 2-4, wherein the backrest is moveably coupled to the one or more panels.

Clause 6. The seat system of Clause 5, wherein the backrest is moveably coupled to the one or more panels by a translator configured to allow the backrest to linearly translate in relation to the one or more panels.

Clause 7. The seat system of any of Clauses 2-6, further comprising a tray table moveably secured to the one or more panels, wherein the tray table is configured to be moved between a privacy position and a forwardly-deployed position.

Clause 8. The seat system of any of Clauses 2-7, further comprising a motor configured to automatically move the seat support between the seating position and the standing position.

Clause 9. The seat system of any of Clauses 2-8, further comprising a lock configured to lock the backrest in a desired position.

Clause 10. The seat system of any of Clauses 2-9, further comprising a motor configured to automatically move the backrest.

Clause 11. The seat system of any of Clauses 2-10, wherein the seat system is configured to be secured to one or more seat tracks within a floor of the internal cabin.

Clause 12. An aircraft comprising:
an internal cabin; and
a seat system within the internal cabin, the seat system comprising:
   a backrest; and
   a seat support moveable between a seating position and a standing position,
   wherein the backrest and the seat support are configured to support an individual in a seated orientation when the seat support is in the seating position, and
   wherein the backrest and the seat support are configured to support the individual in a standing orientation when the seat support is in the standing position.

Clause 13. The aircraft of Clause 12, wherein the seat system further includes one or more panels, wherein the seat support is moveably coupled to the one or more panels.

Clause 14. The aircraft of Clause 13, wherein the seat support is pivotally coupled to the one or more panels by a pivot member.

Clause 15. The aircraft of Clauses 13 or 14, wherein the backrest is moveably coupled to the one or more panels.

Clause 16. The aircraft of any of Clauses 13-15, wherein the seat system further includes a tray table moveably secured to the one or more panels, wherein the tray table is configured to be moved between a privacy position and a forwardly-deployed position.

Clause 17. The aircraft of any of Clauses 12-16, wherein the seat system further comprises a motor configured to automatically move the seat support between the seating position and the standing position.

Clause 18. The aircraft of any of Clauses 12-17, wherein the seat system further comprises a motor configured to automatically move the backrest.

Clause 19. The aircraft of any of Clauses 12-18, wherein the seat system is secured to one or more seat tracks within a floor of the internal cabin.

Clause 20. A method for a seat system within an internal cabin of a vehicle, the seat system comprising a backrest and a seat support, the method comprising:
moving the seat support between a seating position and a standing position, wherein the backrest and the seat support are configured to support an individual in a seated orientation when the seat support is in the seating position, and wherein the backrest and the seat support are configured to support the individual in a standing orientation when the seat support is in the standing position.

As described herein, examples of the present disclosure provide seat systems that allow passengers to extend legs and stretch without moving about an internal cabin of an aircraft. Further, examples of the present disclosure provide seat systems for an internal cabin of an aircraft that promote movement during a flight.

While various spatial and directional terms, such as top, bottom, lower, mid, lateral, horizontal, vertical, front and the like can be used to describe examples of the present disclosure, it is understood that such terms are merely used with respect to the orientations shown in the drawings. The orientations can be inverted, rotated, or otherwise changed, such that an upper portion is a lower portion, and vice versa, horizontal becomes vertical, and the like.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

It is to be understood that the above description is intended to be illustrative, and not restrictive. For example, the above-described examples (and/or aspects thereof) can be used in combination with each other. In addition, many modifications can be made to adapt a particular situation or material to the teachings of the various examples of the disclosure without departing from their scope. While the dimensions and types of materials described herein are intended to define the aspects of the various examples of the disclosure, the examples are by no means limiting and are exemplary examples. Many other examples will be apparent to those of skill in the art upon reviewing the above description. The scope of the various examples of the disclosure should, therefore, be determined with reference to the appended claims, along with the full scope of equivalents to which such claims are entitled. In the appended claims and the detailed description herein, the terms “including” and “in which” are used as the plain-English equivalents of the respective terms “comprising” and “wherein.” Moreover, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

This written description uses examples to disclose the various examples of the disclosure, including the best mode, and also to enable any person skilled in the art to practice the various examples of the disclosure, including making and using any devices or systems and performing any incorporated methods. The patentable scope of the various examples of the disclosure is defined by the claims, and can include other examples that occur to those skilled in the art. Such other examples are intended to be within the scope of the claims if the examples have structural elements that do not differ from the literal language of the claims, or if the examples include equivalent structural elements with insubstantial differences from the literal language of the claims.

What is claimed is:

1. A seat system configured to be within an internal cabin of a vehicle, the seat system comprising:
a backrest; and
a seat support moveable between a seating position and a standing position,
wherein the backrest and the seat support are configured to support an individual in a seated orientation when the seat support is in the seating position, and
wherein the backrest and the seat support are configured to support the individual in a standing orientation when the seat support is in the standing position.

2. The seat system of claim 1, further comprising one or more panels, wherein the seat support is moveably coupled to the one or more panels.

3. The seat system of claim 2, wherein the seat support is pivotally coupled to the one or more panels by a pivot member.

4. The seat system of claim 3, further comprising a lock operatively coupled to the pivot member, wherein the lock is configured to lock the seat support in a desired position.

5. The seat system of claim 2, wherein the backrest is moveably coupled to the one or more panels.

6. The seat system of claim 5, wherein the backrest is moveably coupled to the one or more panels by a translator configured to allow the backrest to linearly translate in relation to the one or more panels.

7. The seat system of claim 2, further comprising a tray table moveably secured to the one or more panels, wherein the tray table is configured to be moved between a privacy position and a forwardly-deployed position.

8. The seat system of claim 1, further comprising a motor configured to automatically move the seat support between the seating position and the standing position.

9. The seat system of claim 1, further comprising a lock configured to lock the backrest in a desired position.

10. The seat system of claim 1, further comprising a motor configured to automatically move the backrest.

11. The seat system of claim 1, wherein the seat system is configured to be secured to one or more seat tracks within a floor of the internal cabin.

12. An aircraft comprising:
an internal cabin; and
a seat system within the internal cabin, the seat system comprising:
a backrest; and
a seat support moveable between a seating position and a standing position,
wherein the backrest and the seat support are configured to support an individual in a seated orientation when the seat support is in the seating position, and
wherein the backrest and the seat support are configured to support the individual in a standing orientation when the seat support is in the standing position.

13. The aircraft of claim 12, wherein the seat system further includes one or more panels, wherein the seat support is moveably coupled to the one or more panels.

14. The aircraft of claim 13, wherein the seat support is pivotally coupled to the one or more panels by a pivot member.

15. The aircraft of claim 13, wherein the backrest is moveably coupled to the one or more panels.

16. The aircraft of claim 13, wherein the seat system further includes a tray table moveably secured to the one or more panels, wherein the tray table is configured to be moved between a privacy position and a forwardly-deployed position.

17. The aircraft of claim 12, wherein the seat system further comprises a motor configured to automatically move the seat support between the seating position and the standing position.

18. The aircraft of claim 12, wherein the seat system further comprises a motor configured to automatically move the backrest.

19. The aircraft of claim 12, wherein the seat system is secured to one or more seat tracks within a floor of the internal cabin.

20. A method for a seat system within an internal cabin of a vehicle, the seat system comprising a backrest and a seat support, the method comprising:
moving the seat support between a seating position and a standing position, wherein the backrest and the seat support are configured to support an individual in a seated orientation when the seat support is in the seating position, and wherein the backrest and the seat support are configured to support the individual in a standing orientation when the seat support is in the standing position.
